(19) United States
(12) Patent Application Publication
(10) Pub. No.: US 2014/0009923 A1
(43) Pub. Date: Jan. 9, 2014

(54) LED TUBE LAMP STRUCTURE

(71) Applicants: Tan Chih Wu, Taipei City (TW); Fu Pao Yang, Daxi Township (TW)

(72) Inventors: Tan Chih Wu, Taipei City (TW); Fu Pao Yang, Daxi Township (TW)

(21) Appl. No.: 13/542,744

(22) Filed: Jul. 6, 2012

(51) Int. Cl. F21V 29/00

(52) U.S. Cl. 362/218

(57) ABSTRACT

An LED tube lamp structure includes a heat-transferring and light-pervious glass tube; a heat-dissipation metal base in the form of an elongated strip with a predetermined curve and bonded to an inner surface of the glass tube via a thermal adhesive; an LED chip circuit board fitted in a receiving seat on a front side of the heat-dissipation metal base and connected to an LED driving circuit; and two electrode covers fitted on two open ends of the glass tube and internally provided with an insertion section each. The heat-dissipation metal base has two ends inserted into the two insertion sections to have an upward tension for tightly contacting with the glass tube. Therefore, heat produced by the LED tube lamp is effectively transferred to the glass tube and dissipated into ambient air to extend the service life of the LED tube lamp.

### FIELD OF THE INVENTION

The present invention relates to an LED tube lamp structure, and more particularly to an LED tube lamp structure that includes an elongated heat-dissipation metal base having a curved rear side attached to an inner surface of a heat-transferring and light-pervious glass tube via a thermal adhesive, so that the LED tube lamp not only provides high brightness, but also enables the heat produced by it to uniformly dissipate into ambient air via the glass tube.

### BACKGROUND OF THE INVENTION

Currently, fluorescent lamps are requisite lighting means in people's daily life. However, thanks to the constant development in various technical fields, light-emitting diodes (LEDs) have been developed as new generation of lighting means. LEDs have many advantages, such as high brightness, fast response time, small volume, low power consumption, energy-saving, safe for use, and long service life. Therefore, LED lamps have been widely used in many applications to replace the conventional fluorescent lamps.

However, for a high-power LED lamp, only 15˜20% of the input power thereof is converted into light while the other 80˜85% of the input power is converted into heat. The produced heat must be timely removed from the LED lamp, lest LED chips in the LED lamp should have an excessively high interface temperature to result in reduced lighting efficiency and shortened service life of the LED lamp. Thus, good heat dissipation forms an important and critical factor in the quality of many LED lighting products.

The currently available LED tube lamp mainly includes a lamp shell formed of an elongated aluminum extrusion strip having a semi-circular cross section for arranging an LED chip circuit board therein; and a lamp shade formed of a plastic or acrylic material having a semi-circular cross section corresponding to the lamp shell. Both the lamp shell and the lamp shade are symmetrically formed at their two longitudinal edges with engaging sections, so that the lamp shell and the lamp shade can be assembled together to form a lamp tube. An LED driving circuit is arranged in a hollow space provided in the lamp shell or is directly arranged in one of two electrode covers fitted on two open ends of the lamp tube to complete an LED tube lamp having a relatively large heat-dissipation surface area.

The conventional LED tube lamp has the following disadvantages in terms of its manufacturing and applications:
(1) While the lamp shell has effectively increased heat-dissipation area, it requires increased amount of metal material to manufacture to thereby increase the weight and the manufacturing cost of the LED tube lamp;
(2) The lamp shade is made of a frosted plastic or acrylic material, which has lower light transmittance compared to the conventional glass tube to thereby largely adversely affect the illuminating effect of the LED tube lamp; and
(3) The conventional LED tube lamp has a lamp tube assembled from a lamp shell and a lamp shade that are made of different materials having different thermal expansion coefficients. Therefore, when the conventional LED tube lamp is in use, it tends to have uneven heat dissipation at the lamp shell and the lamp shade to cause deformation of the lamp tube.

### SUMMARY OF THE INVENTION

A primary object of the present invention is to provide an improved LED tube lamp structure to overcome the drawbacks in the conventional LED tube lamp.

To achieve the above and other objects, the LED tube lamp structure according to the present invention includes a heat-transferring and light-pervious glass tube; an elongated heat-dissipation metal base having a curved back side attached to an inner surface of the glass tube via a thermal adhesive; an LED chip circuit board fitted in a receiving seat formed on a front side of the heat-dissipation metal base and connected to an LED driving circuit; and two electrode covers fitted on two open ends of the glass tube and respectively internally provided with an insertion section. The heat-dissipation metal base has two ends inserted into the two insertion sections in the electrode covers to be held in place and provided with an upward tension.

When the heat-dissipation metal base is attached to the glass tube, it is brought by the upward tension to tightly contact with the inner surface of the glass tube without becoming dropped, deformed or separated from the glass tube when the LED tube lamp is lightened and produces heat. Therefore, the heat produced by the LED tube lamp is effectively transferred from the heat-dissipation metal base to the glass tube and uniformly dissipated into ambient air, allowing the LED tube lamp to work normally and have extended service life.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of an LED tube lamp structure according to a preferred embodiment of the present invention;

FIG. 2 shows the arrangement of a heat-dissipation metal base in a glass tube for the LED tube lamp structure according to the preferred embodiment of the present invention;

FIG. 3 is an assembled sectional side view of the LED tube lamp structure according to the preferred embodiment of the present invention;

FIG. 4 is an assembled perspective view of the LED tube lamp structure according to the preferred embodiment of the present invention; and

FIG. 5 is a cross-sectional view taken along line A-A of FIG. 4.

### DETAILED DESCRIPTION OF THE PREFERRED EMBODIMENTS

The present invention will now be described with a preferred embodiment thereof and with reference to the accompanying drawings.

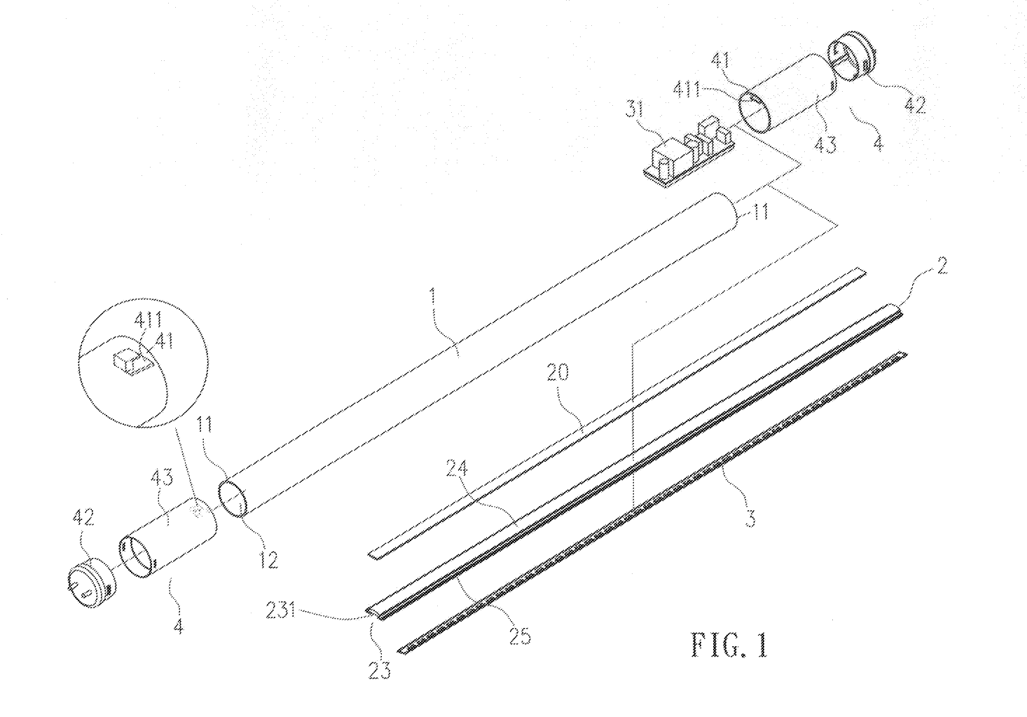

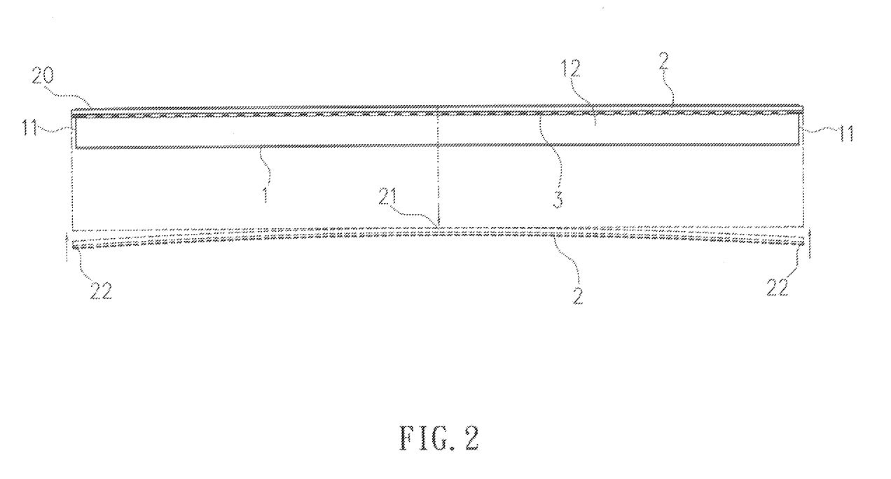

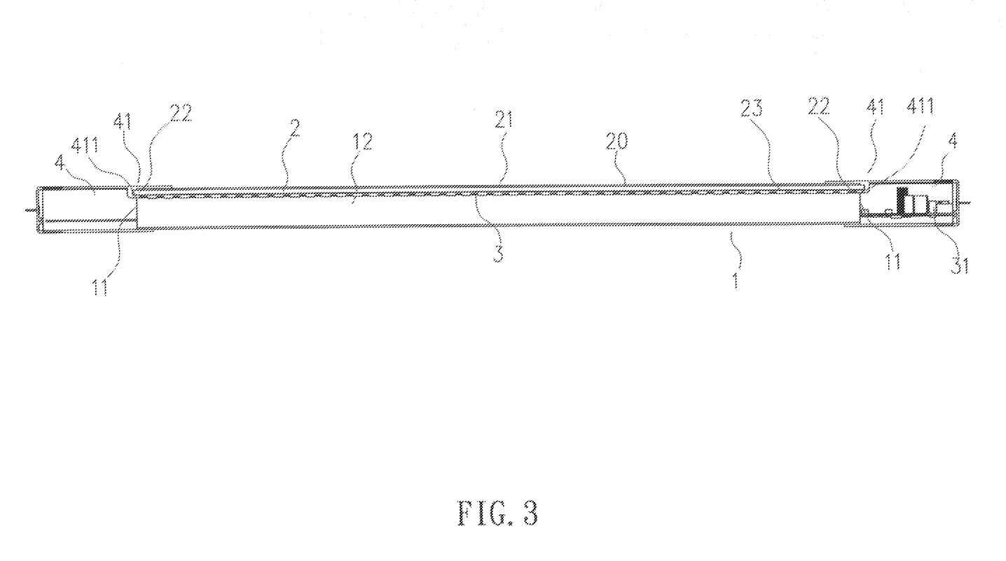

Please refer to FIGS. 1 to 3. An LED tube lamp structure according to a preferred embodiment of the present invention mainly includes a glass tube 1, a heat-dissipation metal base 2, an LED chip circuit board 3, and two electrode covers 4.

The glass tube 1 is a heat-transferring and light-pervious hollow cylindrical member having two open ends 11.

The heat-dissipation metal base 2 is an elongated strip having a slightly arched middle portion 21 located between two end portions 22, and therefore shows a certain degree of curve. The heat-dissipation metal base 2 includes a front side forming a receiving seat 23, a rear side for binding to an inner surface 12 of the glass tube 1 via a thermal adhesive 20. In practical implementation of the present invention, the heat-dissipation metal base 2 can be an elongated aluminum extrusion strip having a substantially arcuate cross section. That is, the rear side of the heat-dissipation metal base 2 has a slightly tensioned arched back 24 with two longitudinal edges formed into two guide rails 25. On the other hand, the receiving seat 23 on the front side of the heat-dissipation metal base 2 is in the form of an inward recessed channel 231.

The LED chip circuit board 3 is fitted in the inward recessed channel 231 of the receiving seat 23 on the front side of the heat-dissipation metal base 2, and is connected to an LED driving circuit 31.

The two electrode covers 4 are fitted on the two open ends 11 of the glass tube 1 to electrically connect with the LED driving circuit 31. In an operable embodiment, the LED driving circuit 31 can be received in one of the electrode covers 4. The two electrode covers 4 are respectively internally provided with an insertion section 41 for two ends 22 of the heat-dissipation metal base 2 to insert thereinto, so that the heat-dissipation metal base 2 is held in place between the two insertion sections 41 and is provided with an upward tension. In practical implementation of the present invention, each of the electronic covers 4 can include an end cap 42 provided with pins and a short cylindrical body 43. The end cap 42 is connected to and closes an outer open end of the short cylindrical body 43. The above-mentioned insertion section 41 is provided in an inner open end of the short cylindrical body 43 and is in the form of an L-shaped plate 411 protruded from an inner upper surface of the short cylindrical body 43.

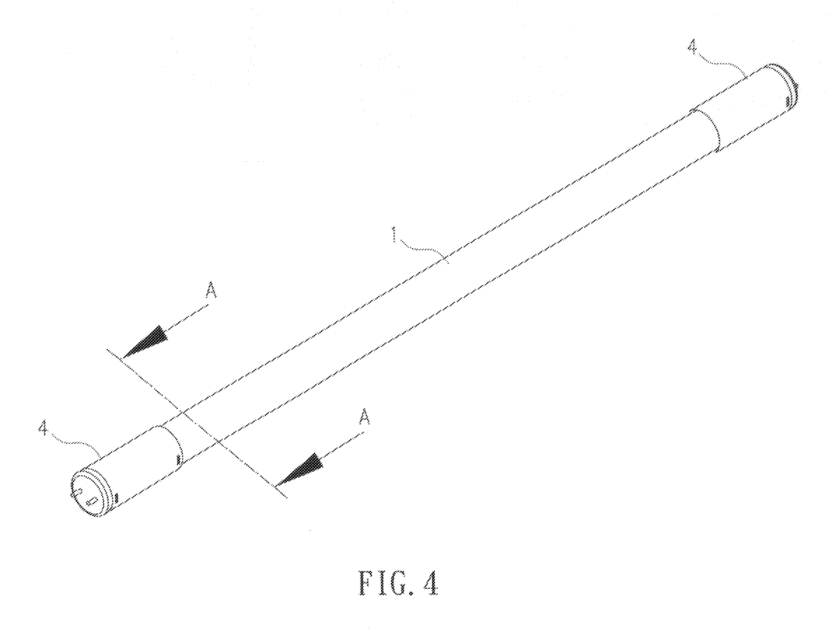

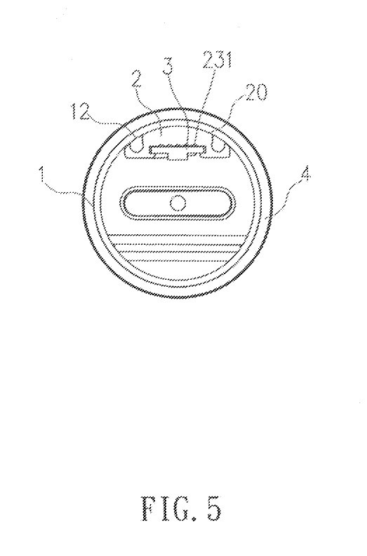

As can be seen in FIGS. 1 to 5, the fully assembled LED tube lamp structure according to the present invention includes an outer portion completely formed of the glass tube 1, which not only has a light transmittance much higher than that of the conventional frosted plastic lamp shade to provide higher brightness, but also provides very good heat transfer effect. With the effective structural design of the present invention, the heat-dissipation metal base 2 can have a largely reduced volume and can therefore be mounted inside the glass tube 1. Therefore, the LED tube lamp structure of the present invention can be conveniently manufactured with fewer materials at lowered costs.

The present invention is characterized in that the heat-dissipation metal base 2 include a slightly arched middle section 21 extended between two ends 22, and therefore has a predetermined curve. In assembling the LED tube lamp structure of the present invention, the slightly curved heat-dissipation metal base 2 can be straightened by applying a minor force to the two ends 22, and the arched back 24 can be bonded to the inner surface 12 of the glass tube 1 via the thermal adhesive 20. When the two ends 22 of the heat-dissipation metal base 2 are inserted into the insertion sections 41 in the two electrode covers 4, the heat-dissipation metal base 2 is well held in place while the L-shaped plates 411 of the insertion sections 41 provide the heat-dissipation metal base 2 with an upward tension. With this effective design, it is ensured an LED tube lamp of any length can always have a heat-dissipation metal base 2 tightly adhered to the inner surface of the glass tube 1 without becoming dropped, deformed or separated from the glass tube 1 even when the LED tube lamp is lightened and produces heat. This is because the heat-dissipation metal base 2 is in tight contact with the inner surface of the glass tube 1 under the upward tension, allowing the heat produced by the LED tube lamp to be effectively transferred from the heat-dissipation metal base 2 to the whole glass tube 1 and be uniformly dissipated into ambient air from the glass tube 1. In this manner, the LED chip circuit board 3 inside the glass tube can maintain normal operation and the LED tube lamp can have effectively extended service life.

The present invention has been described with a preferred embodiment thereof and it is understood that many changes and modifications in the described embodiment can be carried out without departing from the scope and the spirit of the invention that is intended to be limited only by the appended claims.

What is claimed is:

1. An LED tube lamp structure, comprising:
a glass tube being a heat-transferring and light-pervious hollow cylindrical member having two open ends;
a heat-dissipation metal base being a long strip with a predetermined curve, and having a front side formed into a receiving seat and a rear side attached to an inner surface of the glass tube via a thermal adhesive;
an LED chip circuit board being fitted in the receiving seat on the front side of the heat-dissipation metal base and connected to an LED driving circuit; and
two electrode covers being separately fitted on two open ends of the glass tube to electrically connect to the LED driving circuit; the two electrode covers being respectively internally provided with an insertion section, and the heat-dissipation metal base having two ends inserted into the two insertion sections to thereby be fixedly held in place and provided with an upward tension;
wherein, since the heat-dissipation metal base is tightly attached to the inner surface of the glass tube via the thermal adhesive and under the upward tension without the risk of becoming dropped, deformed or separated from the glass tube, heat produced by the lightened LED tube lamp can be effectively transferred from the heat-dissipation metal base to the whole glass tube and uniformly dissipated into ambient air from the glass tube to ensure extended service life of the LED tube lamp structure.

2. The LED tube lamp structure as claimed in claim 1, wherein the heat-dissipation metal base has a substantially arcuate cross section, giving the rear side of the heat-dissipation metal base a slightly tensioned arched back with two longitudinal edges formed into two guide rails; and wherein the receiving seat on the front side of the heat-dissipation metal base is in the form of an inward recessed channel.

3. The LED tube lamp structure as claimed in claim 2, wherein the electrode covers are respectively include an end cap provided with pins and a short cylindrical body; the end cap being connected to and closing an outer open end of the short cylindrical body, and the insertion section being provided in an inner open end of the short cylindrical body and in the form of an L-shaped plate to protrude from an inner upper surface of the short cylindrical body.

4. The LED tube lamp structure as claimed in claim 3, wherein the heat-dissipation metal base is an elongated aluminum extrusion strip, and the LED driving circuit is received in one of the electrode covers.
